(19) United States
(12) Patent Application Publication
(10) Pub. No.: US 2021/0308783 A1
(43) Pub. Date: Oct. 7, 2021

(54) Weldable Aluminum Sheet and Associated Methods and Apparatus

(71) Applicant: ARCONIC TECHNOLOGIES LLC, Pittsburgh, PA (US)

(72) Inventors: Ali Unal, Export, PA (US); June M. Epp, Pittsburgh, PA (US); Donald J. Spinella, Greensburg, PA (US); Raymond J. Kilmer, Pittsburgh, PA (US); Li M. Ming, Murrysville, PA (US)

(21) Appl. No.: 17/235,598

(22) Filed: Apr. 20, 2021

Related U.S. Application Data
(63) Continuation of application No. PCT/US2019/054914, filed on Oct. 7, 2019.
(60) Provisional application No. 62/748,730, filed on Oct. 22, 2018.

(51) Int. Cl. B23K 11/11; B23K 35/02; B23K 35/28

(52) U.S. Cl. CPC B23K 11/11; B23K 2103/10; B23K 35/286; B23K 35/0238

(57) ABSTRACT

A method for resistance spot welding aluminum alloys includes reducing the electrical resistance of an outer surface of the stackup in contact with the anode while leaving the faying surfaces at higher resistances, e.g., by grit blasting the anode contacting surface. High resistance electrodes, e.g., with refractory metal content may be used. Stackups of greater than two members may be used. Sheet material may be prepared having the lower and higher resistance surfaces and used with other sheets having higher resistance surfaces. The cathode contacting surface of the stackup may also have a reduced resistance. The method and sheet may be used in assembling vehicle bodies.

### CROSS-REFERENCE TO RELATED APPLICATIONS

This application is a continuation of International Patent Application No. PCT/US2019/054914, filed Oct. 7, 2019, which claims the benefit of U.S. Provisional Patent Application No. 62/748,730 filed Oct. 22, 2018, entitled “WELDABLE ALUMINUM SHEET AND ASSOCIATED METHODS AND APPARATUS,” each of which is incorporated herein by reference in its entirety.

### TECHNICAL FIELD OF THE INVENTION

The present invention relates to joining materials by welding and more particularly, to methods apparatus and materials for joining aluminum alloy materials by electrical resistance welding.

### BACKGROUND OF THE PRIOR ART

Resistance spot welding (RSW) of steel is used in many industrial applications, e.g., in the manufacture of automobiles, often employing robotic welding equipment. RSW of steel is a fast and low-cost process, flexible for a wide range of metal gauges, easy to operate and to automate. Compared to RSW of steel, aluminum sheet of similar gauge typically requires higher welding current, for a shorter time. Attempts have been made to address this, such as cleaning, surfacing and machining the electrodes, twisting the electrodes upon contact with the stack-up, cleaning and coating the sheets with conversion coatings and the use of sacrificial inserts between the electrodes and the stack-up. Notwithstanding, it remains challenging for manufacturers who currently resistance weld steel sheet to directly substitute aluminum into their joining cells. Alternative methods and apparatus for joining aluminum sheet via RSW therefore remain of interest in the field.

### DISCLOSURE OF THE INVENTION

The disclosed subject matter relates to a method for resistance welding, includes the steps of: (A) providing a first member composed at least partially from aluminum; (B) providing a second member composed at least partially from aluminum, each of the first member and the second member having a first outer surface with a first electrical resistance and a second outer surface with a second electrical resistance and an interior having a third electrical resistance; (C) reducing the electrical resistance of at least a portion of the first outer surface of the first member to produce a lower resistance surface, the second outer surface of the first member retaining a higher electrical resistance than the lower resistance surface and being a higher resistance surface; (D) placing the first member against the second member with the higher resistance surface abutting either the first or second outer surface of the second member producing a two-thickness stackup; (E) providing an electric resistance welder with an anode and a cathode; (F) positioning the anode against the lower resistance surface and the cathode against the second member of the stackup; and (G) passing a welding current through the stackup producing a weld between the first member and the second member at the abutting surfaces.

In another embodiment, the step of reducing is by grit blasting the first outer surface.

In another embodiment, the grit blasting is conducted with aluminum oxide grit producing a surface roughness between 30 μin to 300 μin.

In another embodiment, the step of reducing is by chemical treatment.

In another embodiment, the abutting surfaces are mill finish surfaces.

In another embodiment, the first and second outer surfaces of the first and second members include an oxide layer and wherein the oxide layer is thinned on the lower resistance surface during the step of reducing.

In another embodiment, at least one of the first member and the second member is a sheet.

In another embodiment, both the first member and the second member are sheets.

In another embodiment, further including the step of dressing the anode after the step of passing, and wherein the step of passing is conducted more than 200 times before each step of dressing is conducted.

In another embodiment, further including the step of reducing the electrical resistance of the first outer surface of the second member to produce a second lower resistance surface, the cathode being positioned against the second lower resistance surface during the step of positioning.

In another embodiment, further including the steps of providing a third member composed at least partially of aluminum, wherein the stackup of the first member and the second member is a two-thickness stackup and placing the two-thickness stackup abutting against the third member, producing a three-thickness stackup, the abutting surfaces of the two-thickness stackup with the third member each being a faying surface.

In another embodiment, a lubricant disposed on at least one of the first and second surfaces of the first or second member remains on the surface during the step of passing.

In another embodiment, at least one of the first and second surfaces of the first or second member has a conversion coating that remains on the surface during the step of passing.

In another embodiment, the anode and cathode are composed at least partially of a refractory metal.

In another embodiment, the refractory metal is tungsten.

In another embodiment, an aluminum alloy material, has: a first outer surface with a first electrical resistance; a second outer surface with a second electrical resistance; and an interior having a third electrical resistance, the electrical resistance of the first outer surface being lower than the second outer surface.

In another embodiment, the first and second outer surfaces include an oxide layer.

In another embodiment, the oxide layer of the first outer surface is thinner than the oxide layer of the second surface.

In another embodiment, the of oxide layer of the first outer surface of the first member is in the range of 3 nm to 50 nm in thickness.

In another embodiment, the first outer surface of the first member has a roughness in the range of 30 μin to 300 μin.

In another embodiment, the oxide layer of the first outer surface of the first member is at least partially composed of amorphous Al₂O₃.

the second outer surface of the first member is a mill finish surface.

In another embodiment, at least one of the first and second outer surfaces have lubricant thereon.

In another embodiment, A composite, has: a first member composed at least partially from aluminum; a second member composed at least partially from aluminum, each of the first member and the second member having a first outer surface with a first electrical resistance and a second outer surface with a second electrical resistance and an interior having a third electrical resistance, the electrical resistance of at least a portion of the first outer surface of the first member being lower than the electrical resistance of the second outer surface of the first member, the second outer surface being a higher resistance surface; the first member juxtaposed with the second member with the higher resistance surface abutting either the first or second outer surface of the second member; and a weld joining the abutting surfaces of the first member and the second member.

In another embodiment, the weld is a resistance spot weld.

In another embodiment, the portion of the first outer surface is a grit blasted surface.

In another embodiment, the abutting surfaces are mill finish surfaces.

In another embodiment, the first and second outer surfaces include an oxide layer and wherein the oxide layer of the first outer surface of the first member is thinner than the oxide layer of the second surface thereof.

In another embodiment, the of oxide layer of the portion of the first outer surface of the first member is in the range of 3 nm to 50 nm in thickness.

In another embodiment, the portion of the first outer surface of the first member has a roughness in the range of 30 μin to 300 μin.

In another embodiment, the oxide layer of the portion of the first outer surface of the first member is at least partially composed of amorphous Al₂O₃.

In another embodiment, the second outer surface of the first member is a mill finish surface.

In another embodiment, at least one of the first member and the second member is a sheet.

In another embodiment, both the first member and the second member are sheets.

In another embodiment, the composite further includes a third member composed at least partially of aluminum, the second member abutting against the third member and with a second weld joining the second member to the third member.

In another embodiment, the composite forms part of a vehicle body.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is diagrammatic view of a sheet of aluminum alloy;

FIG. 2 is a diagrammatic view of a stackup of two aluminum alloy sheets between the electrodes of an electrical resistance welder in accordance with an embodiment of the present disclosure;

FIGS. 3A through 3D are a set of four topographical images of a surface of an aluminum alloy after grit blasting in accordance with another embodiment of the present disclosure;

FIG. 4 is a graph of average X-profiles for the topography of five different surfaces of aluminum sheet in accordance with another embodiment of the present disclosure;

FIG. 5 is a scanning electron microscope (SEM) image of the surface of aluminum sheet after grit blasting in accordance with another embodiment of the present disclosure;

FIG. 6 is a photograph of three welded sheet assemblies in accordance with an embodiment of the present disclosure;

FIG. 7 is a set of enlarged photographs of two welded assemblies of FIG. 6 in accordance with an embodiment of the present disclosure;

FIG. 8A is a photograph of welding electrodes used in a sequence of welding operations in accordance with the present disclosure;

FIGS. 8B through 8E is a set of four photographs of cathode welding electrodes used in a sequence of welding tests comparing welding in accordance with the present disclosure to a traditional approach;

FIG. 9 is a graph of weld button diameter achieved over 300 consecutive welds in accordance with a traditional RSW approach;

FIG. 10 is a graph of weld button diameter achieved over 300 consecutive welds in accordance with an embodiment of the present disclosure;

FIG. 11 is a graph of weld time and weld current for RSW in accordance with an embodiment of the present disclosure, standard RSW, and resistance brazing of aluminum sheet, classifying the resultant welds as discrepant or acceptable and by weld size;

FIG. 12 is a graph of the weld force versus weld current for RSW in accordance with an embodiment of the present disclosure (using tungsten coated electrodes, standard RSW (with Class 1 or 2 copper electrodes) and resistance brazing of aluminum sheet, classifying the resultant welds as discrepant or acceptable and by weld size;

FIG. 13 is a photograph of tungsten-faced electrodes in accordance with another embodiment of the present disclosure;

FIG. 14 is a photograph of the tungsten-faced electrodes of FIG. 13 after RSW of mill finish sheet;

FIG. 15 is a set of four diagrams of welding stackups of two sheets in thickness, with one diagram of a traditional RSW stackup and three diagrams of stackups in accordance with embodiments of the present disclosure;

FIG. 16 is a is a set of four diagrams of welding stackups of two sheets in thickness, with one diagram of a traditional RSW stackup and three diagrams of stackups in accordance with embodiments of the present disclosure, the electrodes being combinations of refractory materials (inserts or plated) and standard copper electrodes; and

FIG. 17 is diagram of a welding stackup of three sheets in thickness in accordance with an embodiment of the present disclosure.

### BEST MODE FOR CARRYING OUT THE INVENTION

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

An aspect of the present disclosure is the recognition of several factors that make the process of joining aluminum and its alloys by RSW different from joining steel via RSW. (In this disclosure, “aluminum” shall include pure aluminum and its alloys.) Differences include: i) joining aluminum materials, e.g., aluminum sheets, via RSW requires higher welding current, e.g., 2-3 times that required for steel of a similar gauge; and ii) aluminum exhibits a higher shrinkage during solidification and a higher coefficient of thermal expansion during welding. The above factors require that welding parameters be kept within narrow ranges to avoid weld defects or alternatively, higher forces and currents be used for a wider process window. To mitigate these effects, frequent redressing of the electrodes is required and large-faced electrodes are preferred to mitigate electrode sticking. The higher currents require the industry to weld with direct current (DC) power supplies that operate at higher frequencies (above 800 Hz versus 50 to 60 Hz) in order to reduce the transformer size and utility line draw. Even with these measures, the anode (positive electrode in the DC weld process) starts to pick up aluminum, i.e., aluminum from the sheet adheres to the electrode, eroding the electrode and the sheet in as few as 10 welds for some alloy families, but typically after twenty-five to fifty welds. The erosion of the anode then leads to erosion of the cathode, requiring the electrodes to be refaced to ensure uniform pressure and current distribution. Anode erosion is further accelerated by the Peltier effect, which results in additional heat generation proportional to the differences in the Seebeck coefficients between copper and aluminum. As the current flows between the anode and aluminum sheet, this additional heat is locally generated at the anode-sheet interface, contributing to localized melting of the aluminum sheet proximate the interface. By comparison, the same electrodes can last longer if used in welding steel sheets. The industry addresses electrode wear by employing regular electrode dressing and/or current stepping.

Electrode dressing or refacing for RSW of steel sheets is typically done after approximately 200 to 300 welds. The number of welds between required electrode dressing for similar gauge aluminum sheet is typically to that of steel. Current stepping, which employs incrementally boosting the current after a number of welds have been completed to compensate for electrode wear, is not effective for aluminum since the current is much higher in general and is difficult to increase compared to steel.

In RSW of aluminum, a large electrical current is passed through the sheets to be welded to generate Joule heating. An aspect of the present disclosure is the recognition that the heating at the faying interface (the area of contact between the welded materials, e.g., sheets of aluminum) should be greater than in other areas of the stackup, so that the metal at the faying interface melts before other areas, merges with that of the adjacent sheet and re-solidifies as a weld before the surfaces in contact with either of the electrodes melt. This may be accomplished by selectively controlling the thickness of an oxide layer of different surface(s) of the aluminum materials to be welded, thereby controlling the electrical resistance and Joule heating in different areas of the stackup. This differs from welding sheet with a mill finish, i.e., having oxide layers of thicknesses determined by a rolling process in a rolling mill, or indiscriminately chemically cleaning or applying conversion coatings to the entire aluminum sheet to uniformly reduce the oxide as compared to a mill finish. While chemical cleaning may improve weld consistency over some mill finish flow paths, it requires an increase in welding currents by 10 to 25%, further widening the difference in welding equipment requirements compared to steel sheet RSW.

An aspect of the present disclosure is the recognition that the presence of an oxide layer of high electrical resistance on the surface of the aluminum materials to be welded that are contacted by the electrodes can cause high, localized temperatures at the electrode/sheet interface that leads to sticking and deterioration of the electrode. Further, that the weld current preferentially flows where localized asperities have been deformed, disrupting the oxide layer. In more severe cases where the combination of the electrode contact with the sheet surface topography does not uniformly break through the oxide, this localized reaction between the electrode material and aluminum can cause growth or wear of the electrode, limiting its usable life. In accordance with an embodiment of the present disclosure, this condition can be alleviated by treatment of the surfaces of the sheet(s) to be welded at the interface of the electrode(s) and the sheet(s) to control the electrical resistance through the sheet(s) surface, which reduces heat generation at the electrode interface(s). The treatment of the surface(s) of the sheet(s) in contact with the electrode(s) may be done chemically, by exposure to a plasma, a laser or a water jet, or mechanically (wire brush, scotchbrite abrasion, etc.), by exposure to a blasting media (alumina, iron, glass beads, dry ice, etc.

In accordance with another embodiment of the present disclosure, a robust and simple surface treatment promoting RSW of aluminum sheet is by grit blasting the surface of the sheets contacted by one or both of the welding electrodes, while leaving the faying surfaces of the sheets in the stackup in the untreated (mill finish) condition. Grit blasting can be applied to the entire side opposite to the faying surface side that is contacted by the electrode(s) or locally to the areas of the sheet surface that will be contacted by the electrode(s) when the sheet is welded by RSW.

In accordance with another embodiment, RSW of aluminum to aluminum can be conducted using specialized electrodes which contain physical elements or which are plated with refractory or nickel based materials. When using electrodes of this type, the welding can be conducted on mill finish aluminum sheets, chemically cleaned sheets, sheets that have been coated with a conversion coating or sheets that have their oxide layer reduced by blasting, e.g., grit blasting, on one or both surfaces of the sheets. In one embodiment, the specialized electrodes are used in combination with the differential reduction of oxide layers on at least one electrode contacting surface of a sheet of the stackup, leaving the faying surface of that sheet with a thicker oxide layer, e.g., as provided by a mill finish.

In accordance with another embodiment of the present disclosure, only one electrode contacting surface is treated by reducing the oxide layer, e.g., the anode contacting surface of the stackup is grit blasted, leaving the oxide layers of all other sheets in the stackup undisturbed or of greater thickness, even that surface in contact with the cathode. In another embodiment, all surfaces of the stackup in contact with the anode and cathode electrodes are treated, e.g., grit blasted, to reduce the thickness thereof.

In one embodiment of the present disclosure, two sheets are present in the stackup, such that the resulting weld(s) may be referred to as two thickness or 2T joints. In another embodiment, more than two sheets may be present in the stackup, giving rise to welds of a greater number of thicknesses, e.g., three thickness (3T) joints or greater. In one embodiment, the outer electrode contacting surfaces are treated to reduce the oxide thickness, such that they have a lower contact resistance than the faying surfaces, facilitating the weld joints of aluminum sheets, e.g., 2T or 3T joints or greater. In one embodiment, only the anode electrode contacting side of one sheet in the stackup is treated to reduce the thickness of the oxide layer.

In one embodiment, a stackup in accordance with the present disclosure, e.g., a stackup with one or both electrode contacting surfaces with a reduced thickness oxide layer and with faying surfaces having a thicker oxide layer is compatible with traditional lubricants used during forming/shaping operations. Typically, sheet material, such as sheet aluminum is provided with a surface lubricant that facilitates the forming of the sheet into various shapes by forming dies. For example, automotive parts, such as body panels, are formed with lubricants specially formulated to ensure the part shape can be obtained while minimizing tool (die) wear. A plurality of formed parts may then be welded without cleaning and the lubricants can impact the consistency and quality of the welds. An aspect of the present disclosure is the recognition that lubricants at the faying surfaces do not impact the weld quality as much as those that are exposed to the electrodes. At the electrode contacting surfaces of the stackup, surface lubricants typically accelerate electrode erosion and wear and contribute to weld inconsistency, porosity, cracking, electrode sticking, expulsion and small weld size. An electrode contacting surface that has the oxide layer reduced in thickness, e.g., by grit blasting in accordance with the present disclosure, reduces the amount of heat generated at the electrode interface, compensating for the detrimental influence of the lubricants.

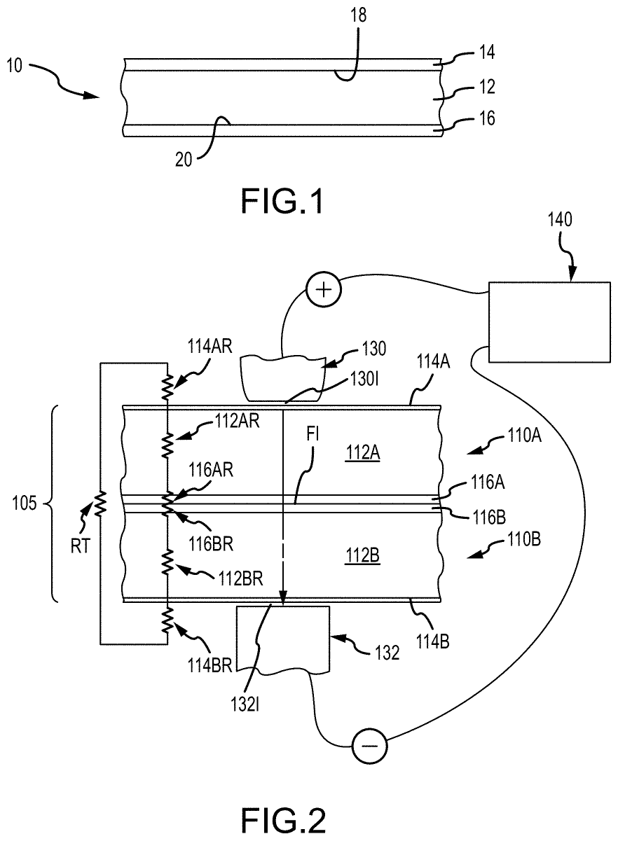

FIG. 1 shows an aluminum alloy sheet 10 with a central alloy portion 12 and layers 14, 16 of aluminum oxide (Al₂O₃) on the upper and lower surfaces 18, 20, respectively. The Al oxide surface can be a mixture of Al oxides, sub-oxides, hydroxides and Mg oxide. In automotive production, it is typical for various forming lubricants and blank wash coatings to also be present on the layers 14, 16 during the welding process. The aluminum alloy may be any one of aluminum wrought alloys in the 1XXX, 2XXX, 3XXX, 4XXX, 5XXX, 6XXX or 7XXX series, including both sheet and extrusions. Additionally, the aluminum alloy may be a cast alloy including but not limited to sand and die castings.

FIG. 2 is a diagrammatic view of a stackup 105 of two aluminum alloy sheets 110A, 110B between the anode 130 and cathode 132 electrodes of an electrical resistance welder 140 in accordance with an embodiment of the present disclosure. The oxide layers 114A, 114B of sheets 110A, 110B, respectively, have been reduced in thickness, whereas the oxide layers 116A, 116B have been left at the same thickness as produced by a manufacturer, e.g., from a rolling mill (not shown). Each of the layers 114A, 112A, 116A, 116B, 112B and 114B have an associated resistance 114AR, 112AR, 116AR, 116BR, 112BR and 114BR to electrical current I flowing from the anode 130 to the cathode 130, 132, adding up to a total resistance RT through the stackup 105. The resistances 114AR, 112AR, 116AR, 116BR, 112BR and 114BR are shown diagrammatically and not to scale, with the resistances 114AR and 114BR shown adjacent to the corresponding oxide layers 114A, 114B, respectively, for ease of illustration. The presence of lubricants and other materials on the surface (not shown) will also contribute to the total resistance RT.

The thickness of oxide layers 14 and 16 (FIG. 1) on an aluminum alloy sheet of types 5xxx and 6xxx obtained from a rolling mill would be in the range of 5 nm to several hundred nm. Resistances measured between the electrodes for a 2T stackup on a 1.5 mm 5xxx-O sheets at forces representative of welding may have a statistical maximum (average+3*standard deviation) exceeding 1500 micro-ohms depending upon the oxide thickness of the materials mentioned previously. After the oxide layer 14 is reduced in thickness in accordance with the present disclosure, e.g., as shown by layers 114A, 114B of FIG. 2, the resultant thickness would be in the range of 5 nm to 50 nm. The electrical resistance through each of layers 114A, 112A, 116A, 116B, 112B and 114B depends upon the composition (having an intrinsic resistivity) and dimensions of the electrical pathway, i.e., cross-sectional area and thickness. Since the resistivity of aluminum oxide is very high substantial reductions in thickness of the oxide layers 114A and 114B will substantially reduce resistance heating to welding current at the electrode junctions. The statistical maximum resistance of the 2T sheet stackup of 1.5 mm 5xxx-O with mechanical abrasion of surfaces 114A and 114B was approximately 500 micro-ohm. In comparison deoxidation of the materials (all sheet surfaces have reduced oxide) can reduce the statistical maximum to be under 500 micro-ohms which requires the welding currents to be higher since the resistance at the welding interface is lower.

Because the oxide layers 116A, 116B have a greater thickness than the oxide layers 114A, 114B, the electrical resistance associated with oxide layers 116A, 116B is greater and the amount of heat generated by the current I passing through oxide layers 116A, 116B is correspondingly greater compared to that generated when the current I passes through oxide layers 114A, 114B. The foregoing differential in resistance and heating permits a given current I to initiate melting and welding of the central alloy portions 112A, 112B proximate the faying interface FI between the oxide layers 116A, 116B before the central alloy portions 112A, 112B proximate the oxide layers 114A, 114B and the anode 130 and cathode 132 melts.

At the small scale of the thickness of an oxide layer, e.g., 114A, it can be expected that variations of the thickness thereof will occur over a give surface area, e.g., a surface area contacted by a welding electrode. At the micro level, the central alloy portion 12 and the layers 14, 16 of aluminum oxide will not be geometrically flat but will vary dimensionally. For example, the upper surface 18 (FIG. 1) of the central alloy portion 12 can be expected to have high points (asperities) and low points (pits) that extend above and below an average height or thickness of the central alloy portion 12. As a result, when an electrode, e.g., 130 is pressed against an oxide surface 114 (FIG. 2) one can expect that the variation in heights of the central alloy portion 112A will give rise to variations in electrical conductivity across the contact area with the anode electrode 130, such that localized regions of high and low conductivity will be experienced. As noted above, other oxides, elements and compounds may be present in the oxide layer, e.g., 114A and/or at the interface 1301. Accordingly, the surfaces with reduced oxide thickness, e.g., 114A, 114B could be more generally described as having a lower resistance (“Low Res”) after treatment, e.g., grit blasting, than untreated surfaces, such as 116A, 116B, which retain a higher resistance (“Hi Res”). The overall contact resistance of an oxide layer, e.g., 114A, 114B or 116A, 116B is a function of the sheet topography, oxide chemistry, and oxide thickness. A low resistance (“Low Res”) interface can therefore be achieved in a number of different ways. For example, a thicker oxide layer over a rough topography may yield the same contact resistance as a thinner oxide layer on a smoother topography. In accordance with one embodiment of the present disclosure, a system, including a combination of topography, oxide thickness and chemistry that provides a uniform, consistent, and lower resistance at the electrode-to-sheet interface while the resistance at faying surface(s) is higher, promotes heating and welding at the faying interfaces and diminishes melting, sticking and electrode degradation at the electrode contact interfaces, e.g., 1301.

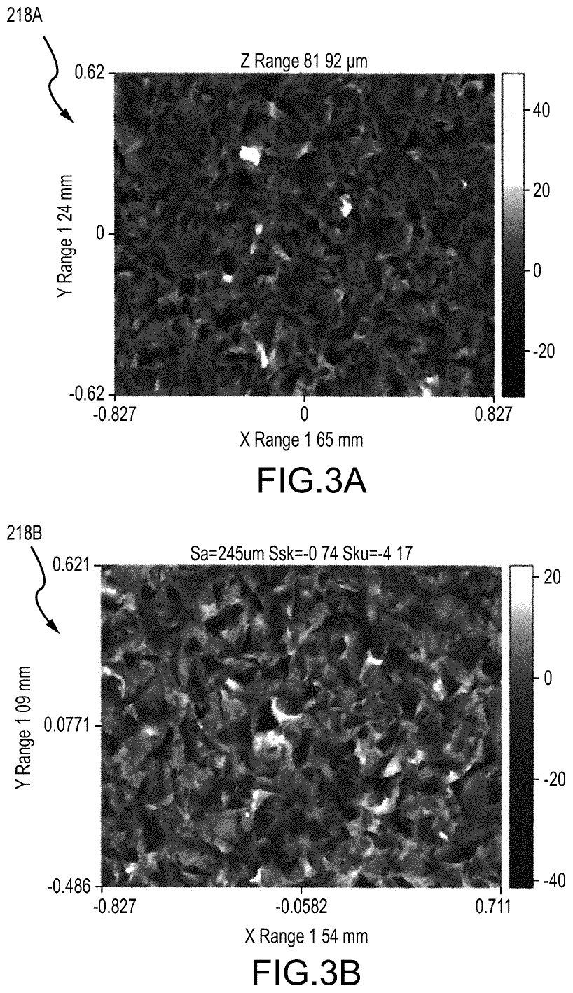

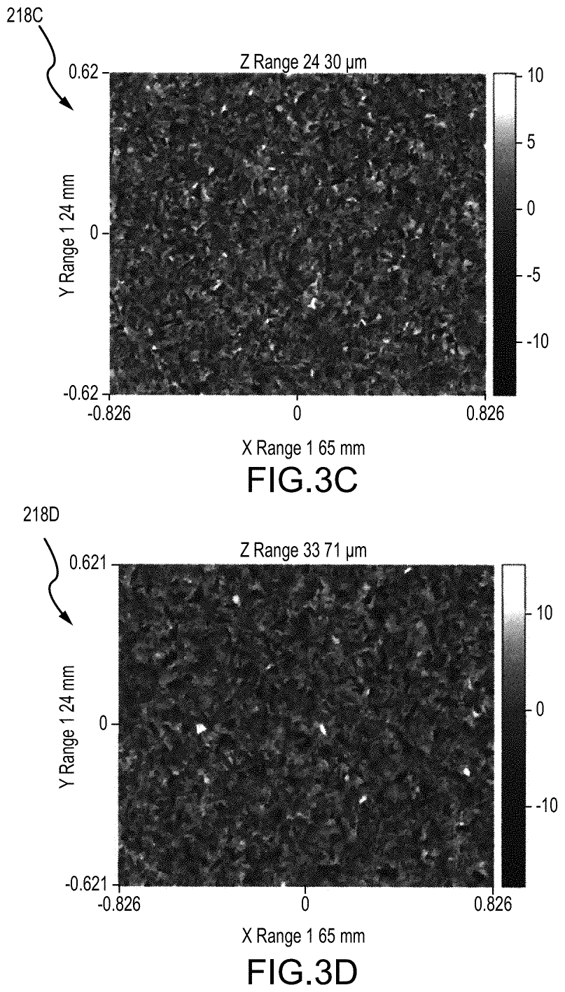

FIG. 3 shows four topographical images 218A, 218B, 218C, 218D of surfaces of a 6022-T4 aluminum alloy sheet that was blasted with alumina grit. To produce the surface shown in 218A, a size 54 grit was blasted on the surface by a Trinco Model 36/BP media blaster operating at 40 psi air pressure at a distance of 5-6 inches from the surface and perpendicular thereto, having a coverage of about 1 and ¼ inch². Seven passes were executed for a total dwell time of 3 minutes, producing a surface with a roughness of Sa 210 μin. To produce the surface shown in 218B, a size 54 grit was blasted on the surface at 60 psi air pressure, but with the other parameters the same as before, producing a surface with a roughness of Sa 240 μin. To produce the surface shown in 218C, a size 120 grit was blasted on the surface at 40 psi air pressure with the other parameters the same as before, producing a surface with a roughness of Sa 90 μin. To produce the surface shown in 218D, a size 120 grit was blasted on the surface at 60 psi air pressure with the other parameters the same as before, producing a surface with a roughness of Sa 113 μin.

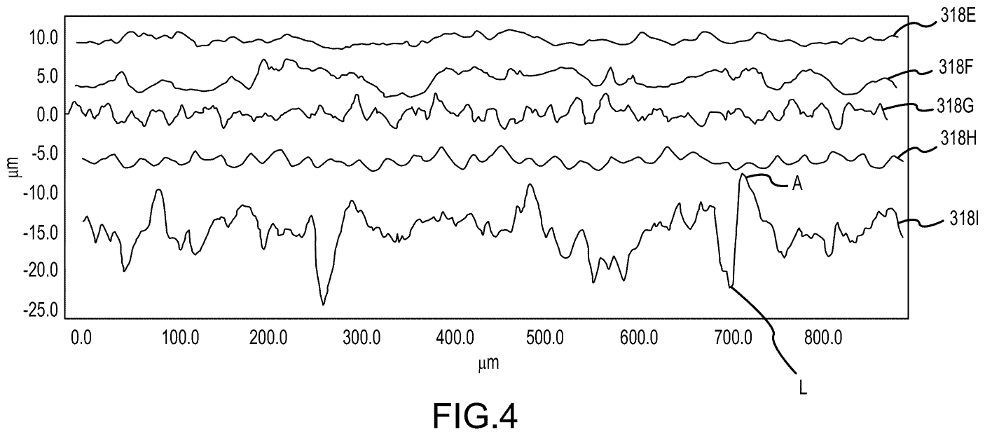

FIG. 4 shows average X-profile line graphs 318E, 318F, 318G, 318H and 318I for the topography of five different surfaces of 6022-T4 aluminum sheet. The X-profiles were obtained from the 3-D topography images obtained using a non-contact optical surface profilometer instrument (e.g., ZeScope). Profile line 318I was generated from a surface blasted by 120 grade alumina grit at 60 psi and demonstrates a height difference of 15 μm between asperities A and low points L. In one embodiment, the surface roughness of the grit-blasted sheet is from ˜30 μin to 300 μin

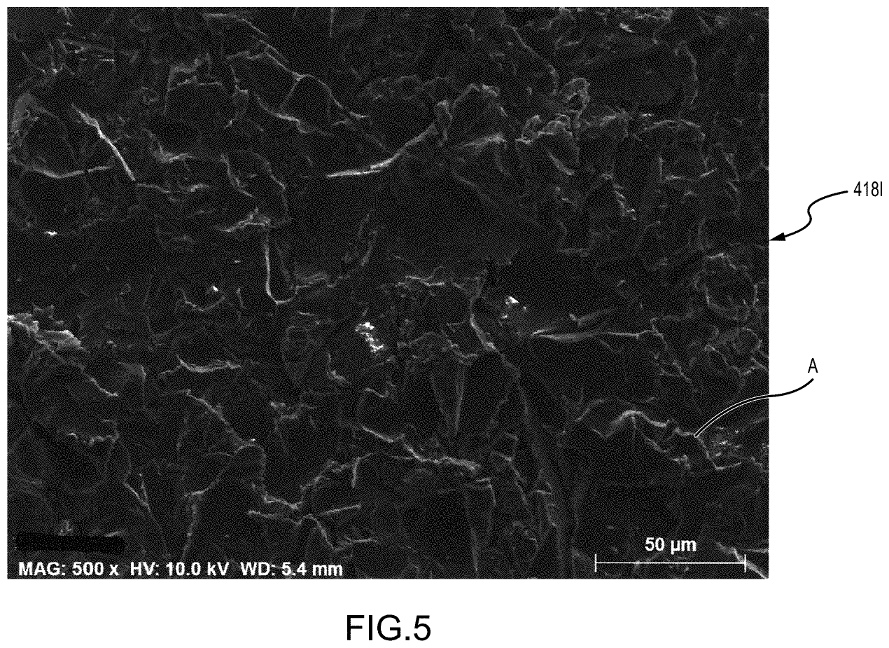

FIG. 5 shows an SEM image of the surface 418I of a 6022-T4 aluminum sheet after grit blasting with 120 grit alumina at 60 psi. This is the same surface as shown by line 318I of FIGS. 4 and 218D of FIG. 3. Sharp asperities A break through an oxide layer like 114A of FIG. 2 when contacted by the electrode 130 and thus create a multitude of electrical flow paths for a uniform current distribution. The surface is characterized by multiple sharp asperities A, as shown in FIGS. 3. and 4. In accordance with the present disclosure, grit blasting removes an initial thick oxide layer, e.g., 16 (FIG. 1) from the surface. The thick oxide layer (6-10 nm typical thickness), e.g. 14, that is removed by grit blasting is immediately replaced by a new, thinner (nominal 3-4 nm) oxide layer, e.g., 114A that is formed on the central alloy portion 112A at room temperature, due to exposure to air. The new oxide layer 114A consists of amorphous Al₂O₃ and, being much thinner than the initial oxide layer 14, has lower electrical resistance compared to the initial, mill finish oxide layers 14, 16. The initial oxide layers 14, 16 are formed during the various processing steps that the sheet 10 is subjected to during preparation by, e.g., hot rolling, cold rolling, thermal treatments, etc., giving rise to their substantial thickness. Other consequences of grit blasting in accordance with the present disclosure are that some of the second phase particles, such as Al12(Fe, Mn)2Si, Al3(Fe,Mn), Mg2Si, Al3Mg2 and variants, are removed during the blasting process, which reduces the chemical non-uniformity of the surface. In addition, grit blasting induces compressive residual stresses in the grit blasted surface(s) which improve electrode/sheet contact as the plastic yielding of the substrate metal starts at lower applied welding forces and approaches a higher level of completion at full force.

### Experimental Results

Weldability tests were carried out on 125×450 mm×0.9 mm thickness panels of 6022-T4 aluminum sheets. The baseline condition was mill finish and had no additional surface treatment or conversion coating applied. The improved condition was grit blasted on one side with 120 alumina grit at 60 psi, as described above. MP404 lubricant was applied to all surfaces at a coverage rate of 100 mg/square meter to represent typical industry conditions, e.g., in the fabrication of automobile bodies and panels. Each condition was tested such that the panels were welded to themselves and a total of 300 welds were consecutively run without changing the welding parameters. The panels were then assembled into a stack, like stack 105 of FIG. 2, with the mill finish surface with undisturbed oxide layer, e.g., like layers 116A, 116B of FIG. 2, positioned together at the faying interface FI and the thin oxide layers 114A, 114B, attributable to grit blasting, positioned adjacent the anode 130 and the cathode 132, respectively, of a welding machine 140. The welding machine 140 was of a type employing medium frequency DC as commonly referred to as MFDC on a pinch-style servo gun with approximately 500 mm throat depth. The welding parameters were as follows: 400daN of weld force, a preheat step of 5 kA for 33 msec immediately followed with a 67 msec weld pulse of 26 kA. All welding was done through a RWMA Class 2 copper male-type electrodes, 16 mm in diameter with 50 mm face radius. On each 125×450 mm panel, 100 consecutive welds were performed at a rate of approximately 10 welds per minute. Welds on each panel were performed along 5 rows, each with 20 welds. After the welding was conducted, the panels were roll-peeled and inspected, such that all 100 welds were destructively tested and button pullout diameters were measured. Weld button pullouts less than 3.5\sqrt{√}GMT where GMT denotes the governing metal gauge were considered discrepant or undersized. Welds not pulling out a button when peeled, i.e., with no interfacial fracture, were considered a discrepant weld, even if the fused interfacial fracture was above 3.5 \sqrt{√}GMT.

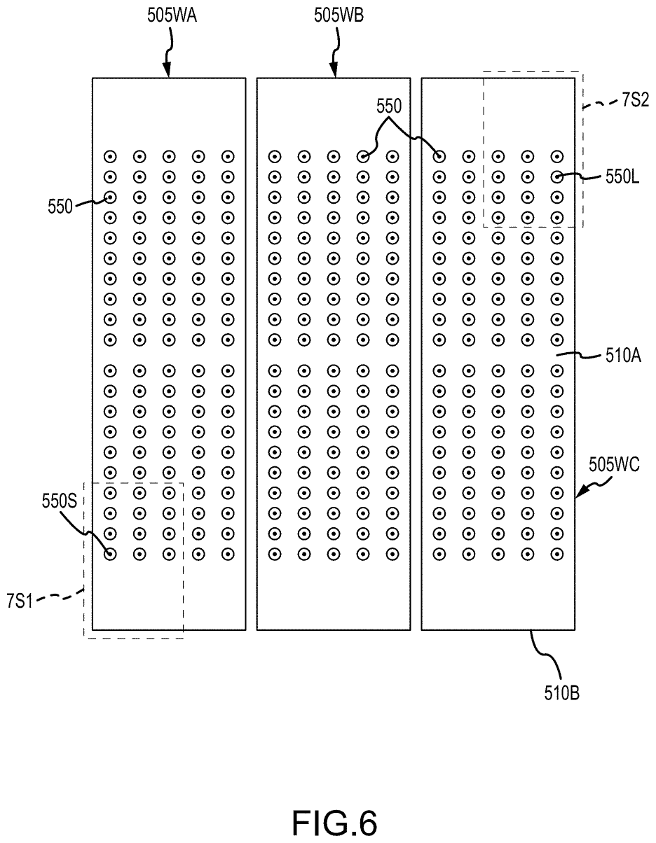

FIG. 6 shows three welded assemblies 505WA, 505WB, 505WC made using the materials and procedure described in the preceding paragraphs for the grit blasted condition. Top sheets 510A were joined to bottom sheets 510B (visible along the lower edge only) by welds 550. A total of three hundred sequential welds 550 were made using the above parameters (one hundred welds 550 per assembly 505WA, 505WB, 505WC).

All welds were good quality and no sticking of the electrodes 130, 132 (FIG. 2) to the sheets 510A, 510B or buildup of aluminum on the electrodes was observed.

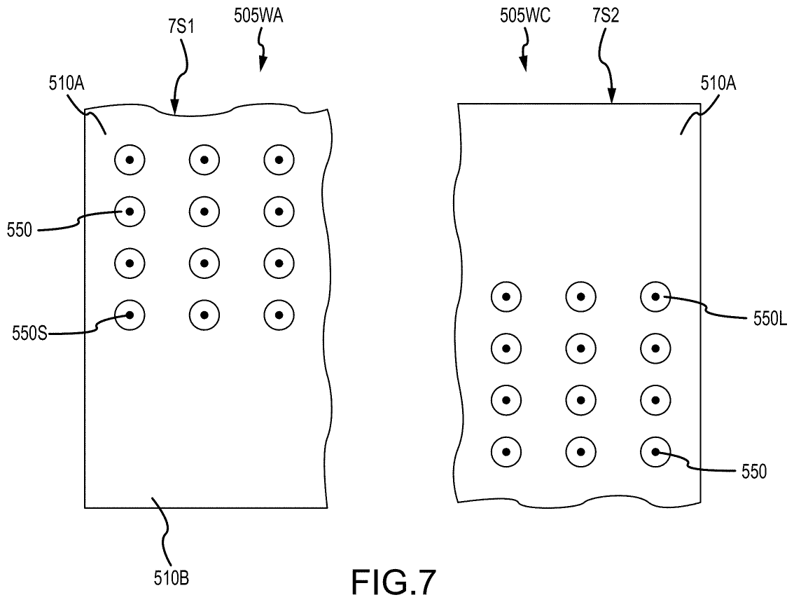

FIG. 7 shows enlarged fragments 7S1, 7S2 of two portions of the assemblies 505WA and 505WC, respectively of FIG. 6. Welding was started at weld 550S and proceeded across and upwardly in sequential rows and columns until one hundred welds were made in assembly 505WA. The same welding approach was undertaken for assemblies 505WB and 505WC, ending with the last weld 550L on assembly 505WC. As can be appreciated from visual inspection, the first weld 550S and last weld 550L have the same dimensions and appearance. The first and last welds 550S and 550L also proved to have the same quality with regards to weld strength and integrity. This indicates that the lack of electrode erosion from the low resistance between the electrode and sheet interface enabled excellent weld quality and consistency over a high number of welding operations.

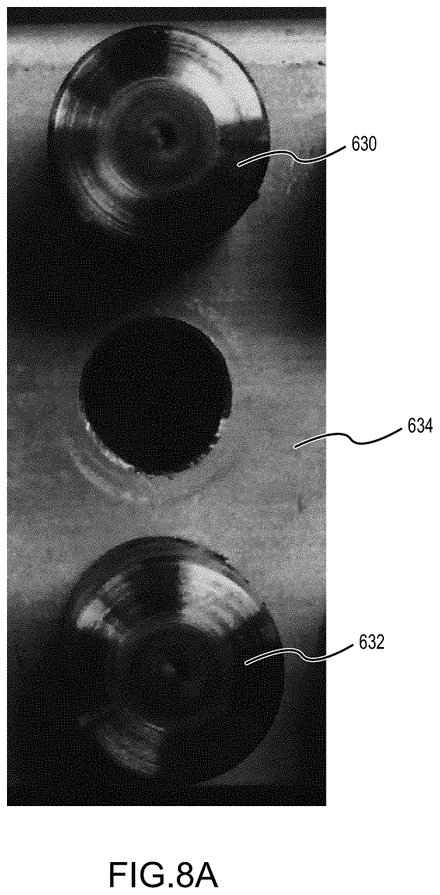

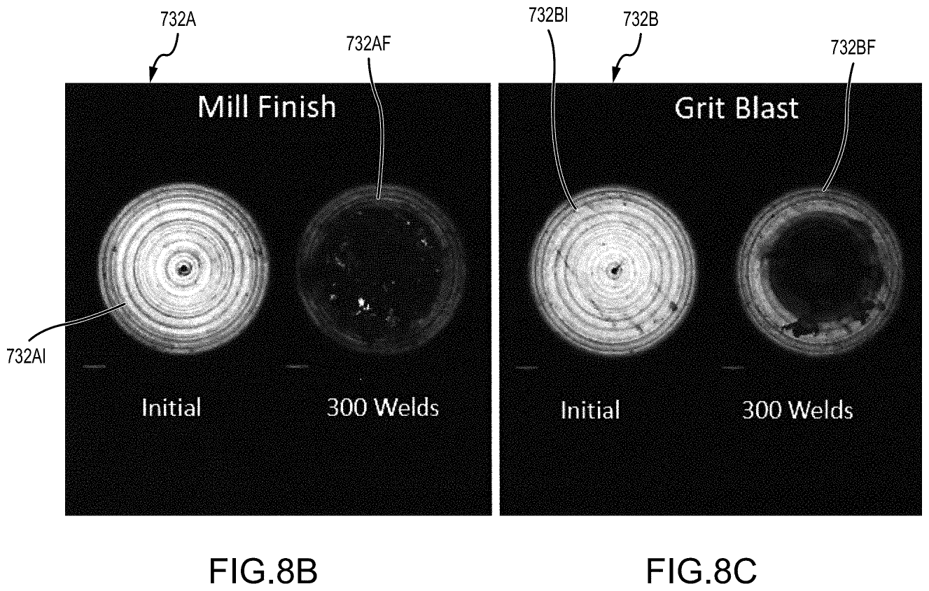

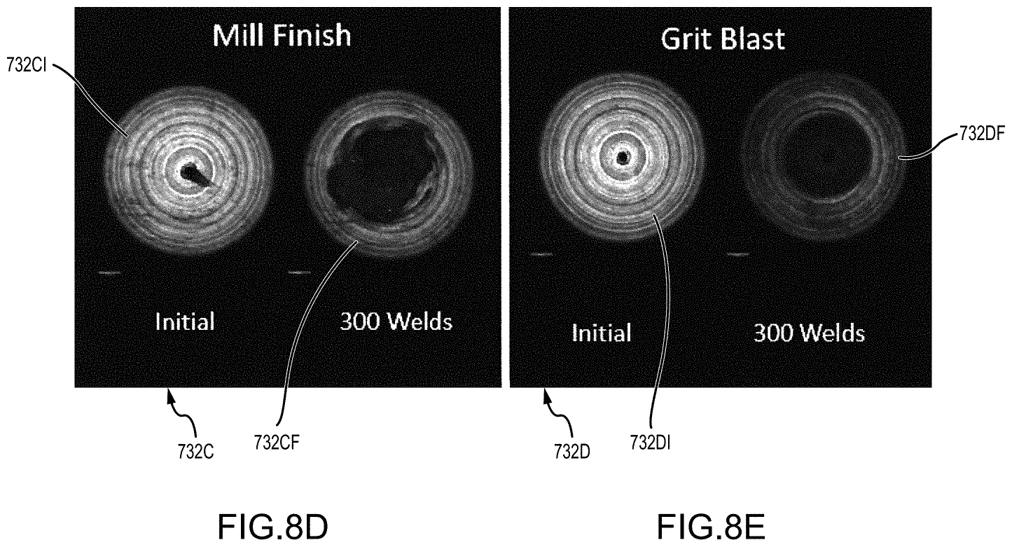

FIG. 8A shows the anode 630 and cathode 632 electrodes mounted on an inspection tray 634 that were used in forming the assemblies 505A, 505B, and 505C, i.e., after completion of the three hundred welds 550. The electrodes 630, 632 were examined and found to show no wear or build-up, indicating that RSW welding of aluminum sheet in accordance with the present disclosure could have continued forming many more welds before dressing of the electrodes was required. Comparable welding of mill finish surfaces with thick oxide layers 14, 16 on both sides of two welded sheets 10 show electrode deterioration after about fifty welds and excessive erosion after three hundred. Further, electrode sticking was observed throughout the three hundred welds of sheet in the mill finish condition.

FIG. 8B shows four comparative photograph sets 732A, 732B, 732C, 732D of cathode welding electrodes 732AI, 732AF, 732BI, 732BF, 732CI, 732CF, 732D1, 732DF, respectively. The cathodes are shown in an initial condition 732AI, 732BI, 732CI, 732DI, before being used in a sequence of welding tests and in a final condition 732AF, 732BF, 732CF, 732DF after making 300 welds. As shown in photograph 732A, after making 300 resistance spot welds on mill finish 5182 aluminum alloy using a traditional approach, the condition of the cathode electrode 732AF is significantly degraded. In contrast, the photograph 732B shows that cathode 732BF is not seriously degraded after making 300 resistance spot welds in 5182 aluminum by RSW welding in accordance with the present disclosure using grit blasting of the oxide layer, e.g., 114A in contact with the anode 130 (FIG. 1). The same results are evident in photographs 732C and 732D, wherein the conditions of cathode 732CF is seriously degraded after the 300 resistance spot welds in 6022 mill finish aluminum alloy compared to cathode 732DF after making the same number of welds in the same type of material, but using grit blasted sheet in accordance with the teachings of the present disclosure.

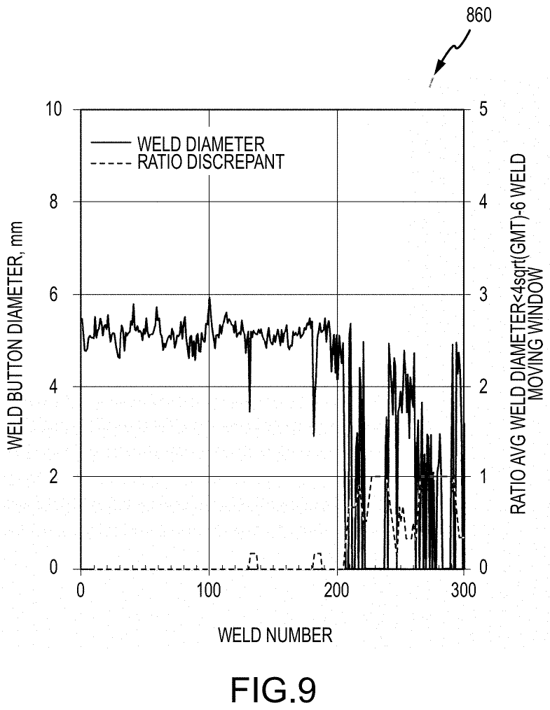

FIG. 9 shows a graph 860 of weld button size (diameter) over the course of 300 RSW welds of two sheets of 0.9 mm thick 6022-T4 aluminum alloy with all surfaces of the sheets in mill finish condition. After approximately 200 welds, the button diameter dropped below the critical value and would be considered unstable. Table 1 below shows the actual weld data from the welding test shown in FIG. 9. The data was normalized to present the weld button diameter, such that measured weld button diameters for 300 consecutive welds on 0.9 mm 6022-T4, all surfaces mill finish. In Table 1, cells with numbers underlined denote discrepant welds (button diameters less than 3.5/GMT) locations on 3 weld panels). FIG. 9 shows that mill finish aluminum exhibited discrepancies after about 200 welds. When safety margins and production variations are taken into consideration, a dressing interval of about 50 welds would be required.

TABLE 1

| | | Weld Panel Column | | | | | | | | | | | | | | | | | | | |
|---|---|---|---|---|---|---|---|---|---|---|---|---|---|---|---|---|---|---|---|---|---|
| Panel | Row | 1 | 2 | 3 | 4 | 5 | 6 | 7 | 8 | 9 | 10 | 11 | 12 | 13 | 14 | 15 | 16 | 17 | 18 | 19 | 20 |
| 1 | 1 | 5.8 | 5.4 | 5.1 | 5.0 | 5.1 | 5.3 | 5.4 | 5.3 | 5.3 | 5.3 | 5.8 | 5.3 | 5.5 | 5.5 | 5.8 | 5.7 | 5.4 | 5.6 | 5.6 | 5.5 |
| | 2 | 5.9 | 5.5 | 5.2 | 5.4 | 5.4 | 5.4 | 5.2 | 5.0 | 4.9 | 4.9 | 5.4 | 5.6 | 5.5 | 5.1 | 5.4 | 5.4 | 5.4 | 5.5 | 5.7 | 5.6 |
| | 3 | 6.1 | 5.5 | 5.5 | 5.6 | 5.5 | 5.5 | 5.4 | 5.3 | 5.5 | 5.4 | 5.8 | 5.5 | 5.3 | 5.4 | 5.4 | 5.4 | 5.5 | 5.6 | 6.0 | 5.7 |
| | 4 | 5.8 | 5.4 | 5.4 | 5.1 | 5.2 | 5.1 | 5.2 | 5.3 | 5.4 | 5.3 | 5.5 | 5.4 | 5.1 | 5.2 | 5.4 | 5.4 | 5.4 | 5.7 | 5.3 | 5.6 |
| | 5 | 5.8 | 5.3 | 5.1 | 4.9 | 5.3 | 5.4 | 4.9 | 5.2 | 4.8 | 5.4 | 5.4 | 5.0 | 5.0 | 5.4 | 5.3 | 5.2 | 5.2 | 5.6 | 5.6 | 6.0 |
| 2 | 6 | 6.2 | 5.8 | 5.5 | 5.3 | 5.1 | 5.4 | 5.4 | 5.3 | 5.6 | 5.4 | 5.6 | 5.7 | 5.8 | 5.9 | 5.7 | 5.8 | 5.7 | 5.6 | 5.6 | 5.4 |
| | 7 | 5.7 | 5.3 | 5.4 | 5.4 | 5.4 | 5.7 | 5.5 | 5.4 | 5.0 | 5.3 | 5.5 | 3.6 | 5.5 | 5.3 | 5.5 | 5.4 | 5.4 | 5.4 | 5.5 | 5.4 |
| | 8 | 5.5 | 5.4 | 5.3 | 5.2 | 5.1 | 5.4 | 5.6 | 5.3 | 5.2 | 5.2 | 5.4 | 5.2 | 5.4 | 5.5 | 5.4 | 5.2 | 5.5 | 5.2 | 5.4 | 5.5 |
| | 9 | 5.6 | 5.1 | 5.1 | 5.2 | 5.2 | 5.5 | 5.4 | 5.4 | 5.4 | 5.4 | 5.6 | 5.3 | 5.4 | 5.4 | 5.6 | 5.5 | 5.7 | 5.6 | 5.8 | 5.5 |
| | 10 | 5.7 | 3.1 | 4.0 | 4.5 | 5.3 | 5.5 | 5.7 | 5.4 | 5.5 | 5.5 | 5.8 | 5.2 | 5.6 | 5.7 | 5.4 | 4.6 | 5.1 | 5.4 | 4.5 | 5.4 |
| 3 | 11 | 4.4 | 5.4 | 5.1 | 4.8 | 5.2 | 2.5 | 0.0 | 0.0 | 0.0 | 5.4 | 5.6 | 0.0 | 0.0 | 0.0 | 2.8 | 3.1 | 0.0 | 4.7 | 4.2 | 0.0 |
| | 12 | 5.2 | 0.0 | 0.0 | 0.0 | 0.0 | 0.0 | 0.0 | 0.0 | 0.0 | 0.0 | 0.0 | 0.0 | 0.0 | 0.0 | 0.0 | 0.0 | 0.0 | 2.8 | 3.5 | 0.0 |
| | 13 | 5.2 | 4.8 | 4.2 | 3.6 | 4.9 | 4.7 | 0.0 | 3.6 | 3.7 | 4.1 | 3.6 | 4.3 | 5.1 | 4.6 | 3.6 | 4.5 | 3.0 | 4.4 | 4.1 | 3.7 |
| | 14 | 5.0 | 0.0 | 2.8 | 3.4 | 0.0 | 2.3 | 3.8 | 0.0 | 2.6 | 0.0 | 3.1 | 3.0 | 0.0 | 3.1 | 0.0 | 2.2 | 0.0 | 0.0 | 2.2 | 2.4 |
| | 15 | 3.1 | 2.2 | 0.0 | 0.0 | 0.0 | 0.0 | 0.0 | 0.0 | 0.0 | 2.8 | 5.2 | 0.0 | 0.0 | 5.2 | 4.5 | 5.0 | 4.5 | 3.2 | 0.0 | 3.4 |

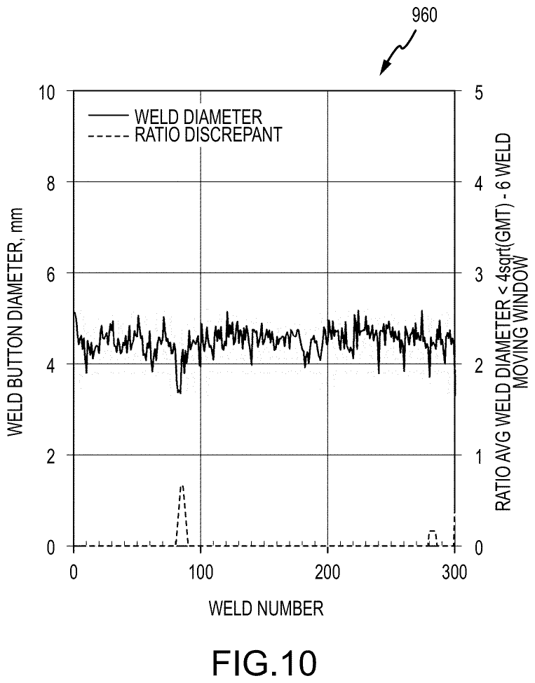

FIG. 10 shows a graph 960 of weld button size for RSW welding of two 0.9 mm thick 6022-T4 aluminum alloy with the electrode side surfaces grit blasted and the faying side surfaces in the mill finish condition. The results illustrated in FIG. 10 reveal that welding proceeded with stable performance through 300 welds and would be expected to achieve even higher levels of successful performance before discrepancies would be observed. Typical industry practice for steel RSW involves electrode dressing at around 250 welds, such that the results illustrated in FIG. 10 compare favorably to steel RSW dressing cycles. Table 2 below shows the actual weld data from the welding test shown in FIG. 10.

TABLE 2

| | | Weld Panel Column | | | | | | | | | | | | | | | | | | | |
|---|---|---|---|---|---|---|---|---|---|---|---|---|---|---|---|---|---|---|---|---|---|
| Panel | Row | 1 | 2 | 3 | 4 | 5 | 6 | 7 | 8 | 9 | 10 | 11 | 12 | 13 | 14 | 15 | 16 | 17 | 18 | 19 | 20 |
| 1 | 1 | 5.4 | 5.3 | 5.0 | 4.7 | 4.9 | 4.9 | 4.6 | 4.9 | 4.4 | 4.1 | 4.8 | 4.6 | 4.5 | 4.8 | 4.4 | 4.5 | 4.6 | 4.7 | 4.7 | 4.5 |
| | 2 | 5.0 | 5.1 | 4.9 | 4.9 | 4.9 | 5.0 | 4.7 | 5.0 | 5.2 | 5.0 | 5.2 | 4.7 | 4.7 | 4.5 | 4.9 | 4.7 | 4.5 | 4.6 | 4.8 | 4.7 |
| | 3 | 4.9 | 4.5 | 4.8 | 5.1 | 4.6 | 4.7 | 4.8 | 5.0 | 4.9 | 4.9 | 5.4 | 5.1 | 4.9 | 4.9 | 4.5 | 4.5 | 4.4 | 4.8 | 4.6 | 5.0 |
| | 4 | 4.3 | 4.1 | 4.4 | 4.6 | 4.4 | 4.7 | 4.9 | 4.9 | 4.7 | 4.8 | 5.3 | 5.0 | 4.8 | 4.9 | 4.7 | 4.8 | 4.5 | 4.5 | 4.8 | 4.6 |
| | 5 | 3.9 | 3.6 | 3.6 | 3.6 | 4.4 | 4.6 | 4.0 | 4.6 | 4.3 | 4.6 | 5.0 | 4.6 | 4.7 | 4.8 | 4.8 | 4.7 | 4.8 | 4.9 | 4.2 | 4.7 |
| 2 | 6 | 5.2 | 4.7 | 4.6 | 4.8 | 5.1 | 4.8 | 4.6 | 4.7 | 4.6 | 4.4 | 5.0 | 5.1 | 4.8 | 5.1 | 4.8 | 5.1 | 4.6 | 4.6 | 4.8 | 4.7 |
| | 7 | 5.4 | 4.9 | 5.2 | 5.0 | 5.2 | 4.7 | 4.8 | 5.1 | 5.2 | 4.8 | 5.0 | 5.0 | 4.6 | 5.1 | 4.8 | 5.1 | 5.0 | 4.8 | 4.5 | 4.2 |
| | 8 | 5.1 | 5.0 | 5.0 | 5.0 | 4.7 | 4.8 | 4.9 | 5.2 | 4.7 | 4.8 | 4.9 | 5.1 | 4.9 | 5.0 | 4.8 | 5.0 | 4.8 | 4.6 | 4.6 | 4.9 |
| | 9 | 4.7 | 4.9 | 4.8 | 4.9 | 4.9 | 4.7 | 4.9 | 5.0 | 4.9 | 4.6 | 5.0 | 5.0 | 4.9 | 4.9 | 4.9 | 5.0 | 5.0 | 4.9 | 4.7 | 4.6 |
| | 10 | 4.6 | 4.2 | 4.4 | 4.5 | 4.3 | 4.6 | 4.8 | 4.8 | 4.9 | 4.8 | 4.8 | 4.6 | 4.4 | 4.3 | 4.5 | 4.8 | 5.1 | 5.0 | 4.7 | 4.8 |
| 3 | 11 | 5.2 | 5.0 | 4.8 | 5.2 | 4.9 | 5.0 | 5.0 | 5.0 | 4.7 | 4.6 | 5.1 | 4.9 | 4.6 | 5.2 | 4.7 | 4.6 | 4.5 | 4.6 | 4.6 | 4.4 |
| | 12 | 5.4 | 5.2 | 4.6 | 5.5 | 4.9 | 5.0 | 5.0 | 5.0 | 5.0 | 5.3 | 4.9 | 5.1 | 4.8 | 5.0 | 5.1 | 4.8 | 4.9 | 5.0 | 4.8 | 4.0 |
| | 13 | 5.0 | 5.0 | 5.0 | 5.2 | 4.7 | 5.1 | 5.1 | 5.2 | 5.0 | 4.9 | 5.1 | 4.8 | 5.0 | 4.9 | 4.8 | 5.0 | 4.5 | 4.8 | 4.7 | 4.1 |
| | 14 | 5.1 | 5.0 | 4.9 | 4.7 | 4.9 | 5.0 | 5.1 | 4.7 | 5.2 | 4.8 | 5.0 | 4.8 | 4.8 | 5.4 | 4.8 | 4.9 | 4.6 | 4.7 | 4.6 | 3.9 |
| | 15 | 4.9 | 4.7 | 4.8 | 4.7 | 4.6 | 5.0 | 4.8 | 5.2 | 4.7 | 4.8 | 4.5 | 4.3 | 4.9 | 5.0 | 4.8 | 5.0 | 4.7 | 4.8 | 4.7 | 3.9 |

The data in Table 2 was normalized to present the weld button diameter in terms of and illustrates the weld consistency achieved using the grit blasted sheet process in accordance with the present disclosure. Specifically, Table 2 shows the measured weld button diameters for 300 consecutive welds on 0.9 mm 6022-T4 (electrode side grit blast textured, faying side mill finish). Unlike the results shown in FIGS. 9 and Table 1 that relate to welding aluminum sheet in the mill finish condition, there were no cold welds lacking a weld button. The only difference between the two welding conditions illustrated in FIGS. 9 and 10 was that the electrode side surface of the sheets welded in FIG. 10 was grit blasted, the faying surfaces in both FIGS. 9 and 10 being mill finish. In accordance with the present disclosure, controlling the wear of the electrodes and, in particular, the wear and erosion of the anode significantly improves the long-term consistency of the resistance welding process for aluminum.

In another embodiment of the present disclosure, only the thick oxide layer 14 on the sheet 10 in contact with the anode 130 is removed by grit blasting, i.e., at interface 1301, leaving the thick oxide layer 14 present on the sheet 10 in contact with the cathode 132, i.e., at interface 1321. An aspect of the present disclosure is the recognition that deterioration sets in earlier and grows faster at the interface 1301 between the stackup 105 and the anode 130. As a consequence, a stackup 105 having a reduced oxide thickness only on the side in contact with the anode 130, i.e., at interface 1301, will display improved, i.e., lower, dressing frequencies.

The use of electrode-contacting sheet surface(s) with reduced resistances at the electrode interface(s) 1301 also impacts the range of electrode types and/or materials that may be productively used. Copper-based electrodes exhibit high strength and conductivities approaching 80% IACS. Typical copper electrodes include RWMA Class 1 (CuZr or copper association designation C15000), Class 2 (CuCr or C18200 and CuCrZr C18150) and dispersion strengthened coppers (DSC or C15760). Class 1 electrodes are purposely selected to have exceptional electrical and thermal conductivities to keep heat generated at the contact interfaces low, preventing damage and sticking. Aluminum mill finish surfaces typically require very high conductivity copper (i.e. Class 1) to keep sticking to a minimum, whereas RSW of steel can use Class 2 electrodes. RSW of aluminum requires additional Joule heating from higher electrical currents compared to RSW of steel sheet, since the Class 1 electrodes do not provide as much secondary heat as Class 2 electrodes.

In accordance with another embodiment of the present disclosure, refractory metal electrodes including, but not limited to, materials such as tungsten (100W or C74300), tungsten-copper blends commonly referred to as elkonite (1W3/5W3 or C74450, 10W3 or C74400, 30W3 or C74350), and molybdenum (C42300) can produce welds in aluminum at significantly less current than the traditional Class 1 and 2 copper grades. The refractory metal electrodes have electrical conductivities less than 60% IACS and often range in the 30 to 50% range.

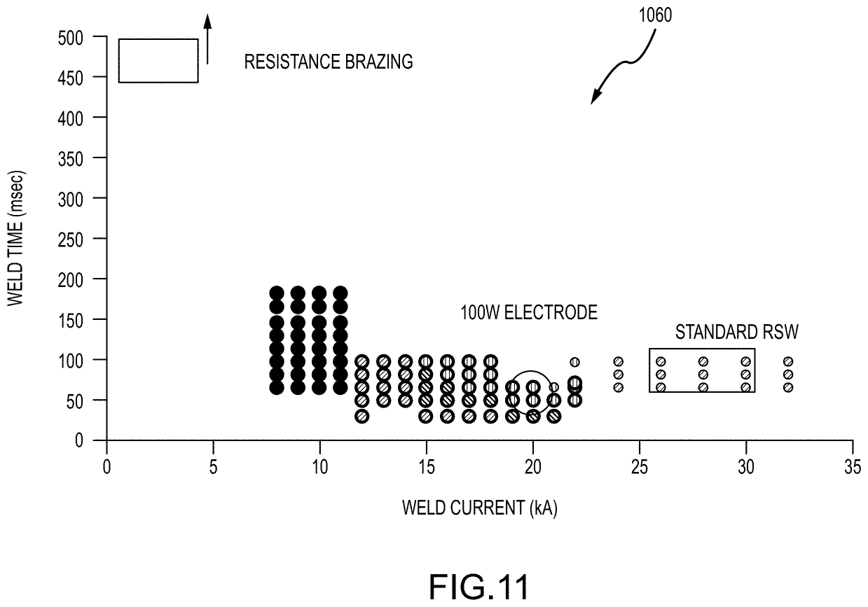

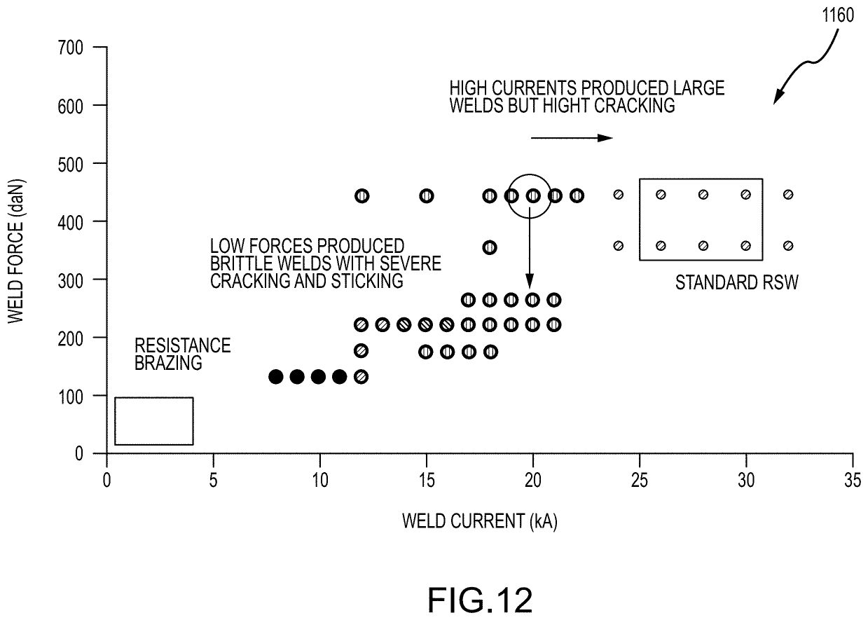

FIGS. 11 and 12 show graphs 1060 (considering the effects of Weld current and Weld time), and 1160 (considering the effects of Weld current and Weld Force), respectively, and characterize the welds produced on 1.1 mm 6022-T4 sheet with both Class 2 (noted as Standard RSW) and pure tungsten (noted as 100W) electrodes. The graphs 1060 and 1160 show the welding results using mill finish sheets, where blue dots indicate less than 3 sqrt(t), orange—3 to 4 sqrt(t), yellow—4 to 5 sqrt(t), green—5 to 6 sqrt(t). As shown in both figures, welds can be produced with the tungsten electrode at currents 20 to 30% lower current than traditional Class 2 electrodes, while using similar welding time and force. This process is different from resistance brazing which operates at much lower forces but with higher welding times than the resistance welding processes. For each individual welding parameter set, several welds were produced, peel tested and resultant welds measured. Currents ranging from 12 to 22 kA produced acceptable weld button sizes. This is a substantial reduction in current compared to 24 to 32 kA for traditional Class 2 welding electrodes. Equipment sized to weld steel usually has a weld current limit of around 20 kA. Thus, the refractory metal electrodes offer the end user the ability to join aluminum sheet via RSW without changing the existing equipment currently welding steel. In addition to Tungsten, electrodes having a Molybdenum or Nickel component may be similarly utilized, either in pairs or with one electrode made from one material and another electrode made from a different material of this group. This offers capital cost savings from welding equipment (transformers, guns, controls), robotics (lighter payload capability, faster robot speeds), substation capacity (do not need to upsize) and flexibility (process multiple materials with the existing system).

While refractory metal based electrodes offer advantages in terms of lowering the welding current required, they do not exhibit the stable, long-term performance of traditional copper electrode materials. In producing the welding results of FIGS. 11 and 12, the tungsten electrodes were cleaned with 200 grit emery paper after each weld parameter setting (every 3 to 5 welds). When making more than 10 welds continuously, significant aluminum buildup was observed on the anode.

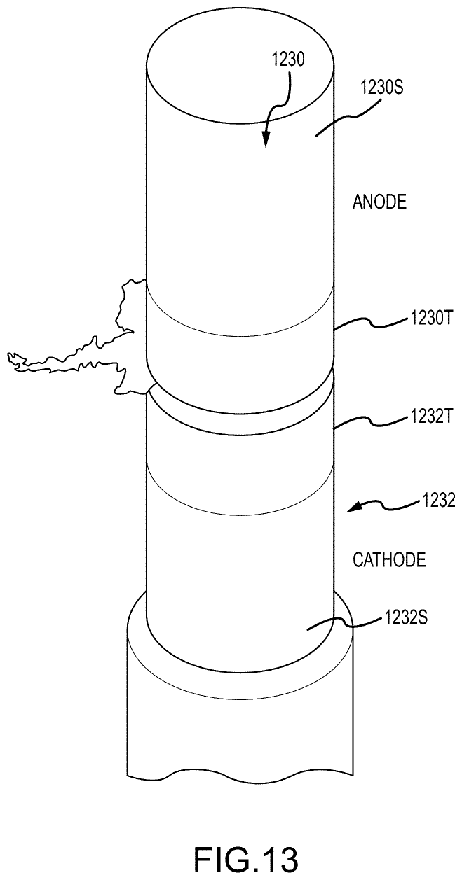

FIG. 13 shows tungsten electrodes 1230 (anode) and 1232 (cathode) employed for both weld process parameter testing and for testing electrode life. 6 mm tungsten discs 1230T, 1232T were brazed to standard CuCr electrodes 1230S, 1232S to form the composite anode 1230 and cathode 1232, respectively, hereinafter referred to more simply as “tungsten electrodes”. The tungsten electrodes 1230, 1232 were used on the same welding equipment described above, i.e., 500 mm pinch gun, 16 mm electrode diameters, 50 mm face radius, etc., but using lower currents than traditional Class 2 copper electrodes, e.g., 20 kA at 67 msec for the tungsten electrodes, versus 28 kA at 67 msec for a copper electrode. This setup was used to weld two mill finish, 6022-T4 aluminum alloy sheets of 1.1 mm thickness each. Within approximately 10 welds, significant anode sticking was observed and a large amount of material was pulled from the electrodes.

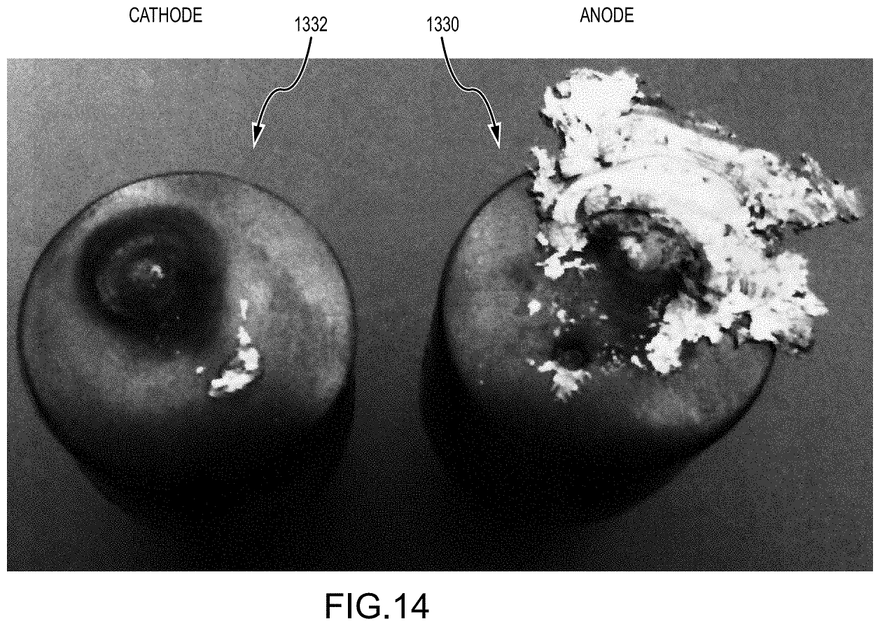

FIG. 14 shows tungsten electrodes, i.e., anode 1330 and cathode 1332, like those shown in FIG. 13, after 100 consecutive welds under the conditions described in the preceding paragraph. While the cathode 1332 had little buildup, the anode 1330 picked up significant amounts of aluminum, causing localized cracking in the tungsten portion (See 1230T of FIG. 13). These results indicate that mill finish aluminum sheet does not accommodate RSW welding with refractory electrodes due to the high heat and sheet material pickup associated with the relatively high resistance exhibited by the refractory electrodes.

An aspect of the present disclosure is the recognition that the degradation/wear of the anode and the cathode attributable to welding are related. This relationship was shown in a series of 100 welds made on the same 1.1 mm 6022-T4 sheet described above in the preceding paragraphs using Class 2 copper electrodes and tungsten electrodes. In these tests, the copper anode and the tungsten anode were both dressed with 200 grit emery paper after every weld, but the cathode was not cleaned during the 100 consecutive welds. For both tungsten and copper electrodes, no wear was observed on the cathode, indicating that if the anode does not exhibit appreciable wear and erosion, then the cathode will also not exhibit wear. In an embodiment of the present disclosure, buildup on a tungsten anode can be mitigated by a low resistance interface with the stackup that is established in accordance with the teachings of the present disclosure, e.g., by grit blasting. The grit blasted anode contact surface can provide this low resistance interface, enabling use of tungsten electrodes and thereby realizing the associated advantages of using a lower welding current.

In another experiment, both surfaces of each of two 6022-T4 sheets like those used in the welding test described above were grit blasted. MP404 lubricant was applied to all sides of the sheets. Welding by RSW was conducted as described above, using the same welding settings. This experiment showed that no welding had taken place. This result was attributed to the low electrical resistance of the treated surfaces at the faying interface, which did not create enough heat for melting of the adjoining surface and their welding together.

An additional set of 300 RSW welds were conducted for a variety of other aluminum alloy sheet surfaces on 0.9 mm 6022-T4 using the same class 2 electrode materials, geometries, welding equipment and weld parameters described previously. These materials were run in both a mill condition and with Arconic 951™ pretreatment for conventional and EDT finished surfaces. These materials, which are representative of commercially available aluminum alloy sheet materials currently supplied in the auto industry, displayed electrode erosion and sticking similar to the mill finish sheet described above, i.e., electrode deterioration after 50 welds and excessive erosion after 300 welds.

Aspects of the present disclosure relate to methods to enhance the surface of an aluminum sheet that improves the consistency and repeatability of the resistance welding process to reduce the need for destructive teardowns and for improving the efficiency of the RSW process as compared to RSW welding mill finish aluminum. In accordance with an embodiment of the present disclosure, selective surface enhancement at the electrode/stack-up interface(s) results in lower resistance at the electrode/stack-up interface than at the sheet-to-sheet (or faying) surfaces, reducing the wear and erosion of the electrodes. When using conventional copper-based electrodes, electrode dressing and replacement can be extended to increase the efficiency of the process. Additionally, the selective surface enhancement enables alternative electrode materials, such as, refractory based metals and alloys and nickel-based alloys to be employed. These electrode materials provide additional heat to the weld because they have lower electrical and thermal conductivities and can only be used with the surface enhancement since conventional aluminum surfaces damage electrodes made from these materials very quickly. The approach of the present disclosure allows resistance welding at a reduced current level, enabling users to weld aluminum with the same resistance welding equipment employed to weld steel.

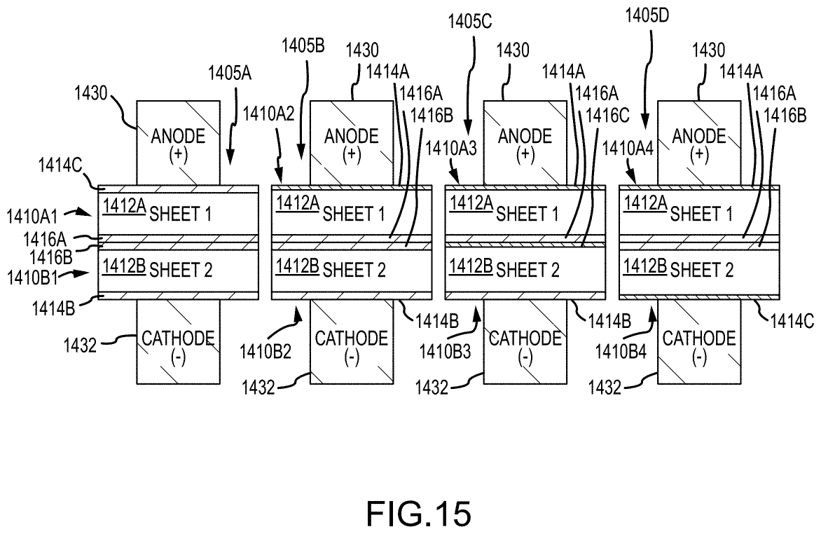

FIG. 15 shows four, two sheet (2T) RSW stackups 1405A, 1405B, 1405C, 1405D of aluminum alloy sheets, e.g., 1410A1 and 1410B1, positioned between a pair of welding electrodes, i.e., anode 1430 and cathode 1432. Stackup 1405A shows the baseline configuration which consists of two mill finish sheets 1410A1, 1410B1, which may or may not have surface treatments or conversion coatings applied consistently to all surfaces. As described above, an aspect of the present disclosure is a stackup with a lower electrical resistance oxide layer 1414A on the surface of the sheet, e.g., 1410A2 of stackup 1405B at the interface with the anode 1430, and a higher electrical resistance layer, e.g., 1416A at the faying interface on the opposing side. In one embodiment, as shown by stackup 1405B, the resistances on both sides, 1414A and 1416A are stable and consistent across the contact interface with the anode 1430 on one side and across the interface between the top sheet 1410A2 and the bottom sheet 1410B2 (the faying interface). The preferred orientation of the top sheet 1410A2 is with the low resistance side, (“Low Res”) placed against the anode electrode 1430 for DC type welding systems. The stackups 1405B, 1405C and 1405C illustrate various stackups wherein the Low Res layer 1416A is utilized to provide improved RWS over the baseline stackup 1405A. In each of stackups 1405B, 1405C and 1405C, the anode 1430 contacts the low resistance surface layer 1414A. The upper sheet 1410A2, 1410A3, 1410A4 with Low Res layer 1414A can be paired with a conventional mill finish sheet, e.g., 1410B2, as in stackup 1405B and still provide enhanced weld performance over the baseline configuration of stackup 1405A. Alternatively, the lower sheet may have a Low Res surface layer 1416C (stackup 1405C) or 1414C (stackup 1405D) which is at the faying interface or the cathode interface and provide enhanced welding over the baseline of stackup 1405A. This flexibility is beneficial in a commercial environment where components received from multiple sources are joined together, since having the high weldability sheet at least at the anode side will increase the RSW performance compared to a baseline configuration.

As shown in stackup 1405C a sheet 1410A3 with a Low Res layer 1416A can be paired with another similar sheet 1410B3. While it is preferred that Low Res layer 1416C is positioned to contact the cathode 1432 as shown in stackup 1405D to reduce wear or erosion of the cathode 1432, it can be positioned against High Res layer 1416A at the faying interface and still result in improved RSW of the layers 1410A3 and 1410B3 compared to the baseline configuration. All surfaces of the bottom sheet, e.g., 1410B3 or 1410B4 can be of the Low Res type but this will require weld currents at least 10% to 20% higher than that required for RSW of the stackup 1405D. Table 3 shows possible surface position combinations like those shown in FIG. 15, specifically, sheet orientation of high weldability product for enhanced weld performance for two thickness stackups.

TABLE 3

| | | Baseline | Present Embodiment | | |
|---|---|---|---|---|---|
| Sheet 1 | Upper | Mill | Low Res | Low Res | Low Res |
| | Lower | Mill | Mill | Mill | Mill |
| Sheet 2 | Upper | Mill | Mill | Low Res | Mill |
| | Lower | Mill | Mill | Mill | Low res |

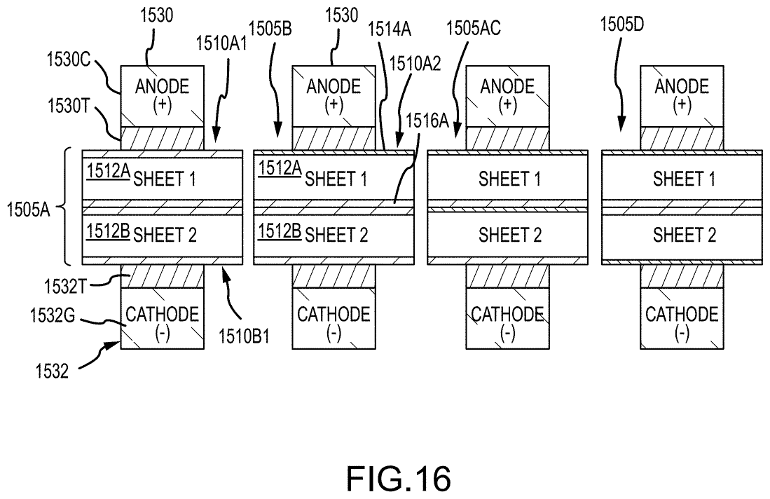

FIG. 16 shows four, two sheet (2T) RSW stackups 1505A, 15056, 1505C, 1505D of aluminum alloy sheets, e.g., 1510A1 and 1510B1, positioned between a pair of welding electrodes, i.e., anode 1530 and cathode 1532. Stackup 1505A shows the baseline configuration which consists of two mill finish sheets 1510A1, 1510B1, which may or may not have surface treatments or conversion coatings applied consistently to all surfaces. As described above, an aspect of the present disclosure is a stackup with a lower electrical resistance oxide layer 1514A on the surface of the sheet, e.g., 1510A2 of stackup 1505B at the interface with the anode 1530, and a higher electrical resistance layer, e.g., 1516A at the faying interface on the opposing side of the top sheet, e.g., 1510A2. In one embodiment, the Low Res surface 1514A allows use of anodes and cathodes made from materials with a low thermal and electrical conductivity without significantly melting the aluminum sheets 1512A, 1512B at the interface with the anode 1530 and the cathode 1532 and damaging the electrodes. Thus, electrode materials, such as Tungsten, can be employed, which can lower the required welding current by at least 10%. Refractory electrodes may also be employed and produce a differently shaped weld nugget with a distinct shape signature. Welds made with refractory electrodes are squarer in cross section than traditional RSW welds produced with copper electrodes, which are more elliptical.

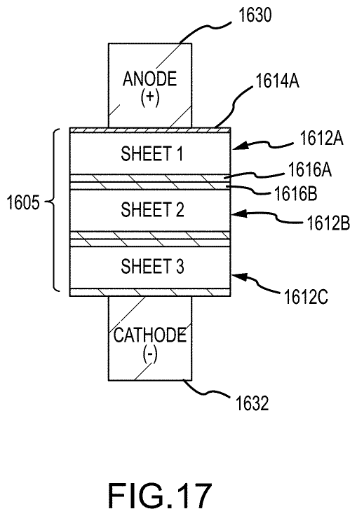

FIG. 17 shows another embodiment of the present disclosure with a three thickness (3T) RSW welding stackup 1605. A 3T RSW stackup of aluminum is uncommon due to variations in the sheet surfaces and would typically require a two-step operation where two sheets are first welded and then one of those sheets are welded to the third sheet. This two-step approach increases the number of welds and ultimately the cost of the process for joining three aluminum sheets. The development of a Low Res layer 1614A on the top sheet 1612A, e.g., by grit blasting, may be used to facilitate RSW of a 3T stackup 1605. As in the case of a 2T joint, the anode electrode 1630 contacts the Low Res layer 1614A of the first sheet 1612A to reduce electrode wear and erosion. Table 4 below describes the relative resistance level and position of sheet surfaces of 3T stackups, including a baseline stackup where all the surface are mill finish, as well nine variations in accordance with the present disclosure utilizing at least one sheet having a Low Res surface at the anode interface. Sheet 1 is the top sheet that contacts the anode 1630 at the upper surface thereof. In some of the nine variations, two sheets of the three have one Low Res surface and in some of the nine variations, three sheets of the three have one Low Res surface.

TABLE 4

| | | Baseline | Present Embodiment | | | | | | | | |
|---|---|---|---|---|---|---|---|---|---|---|---|
| Sheet | Upper | Mill | Low | Low | Low | Low | Low | Low | Low | Low | Low |
| 1 | | | Res | Res | Res | Res | Res | Res | Res | Res | Res |
| | Lower | Mill | Mill | Mill | Mill | Mill | Mill | Mill | Mill | Mill | Mill |
| Sheet | Upper | Mill | Mill | Low | Mill | Mill | Mill | Low | Mill | Low | Mill |
| 2 | | | | Res | | | | Res | | Res | |
| | Lower | Mill | Mill | Mill | Low | Mill | Mill | Mill | Low | Mill | Low |
| | | | | | Res | | | | Res | | Res |
| Sheet | Upper | Mill | Mill | Mill | Mill | Mill | Low | Mill | Mill | Low | Low |
| 3 | | | | | | | Res | | | Res | Res |
| | Lower | Mill | Mill | Mill | Mill | Low | Mill | Low | Low | Mill | Mill |
| | | | | | | Res | | Res | Res | | |

Sheets 2 and 3 may be conventional aluminum (mill finish) or sheets with a Low Res side. Since Low Res displays good welding performance when paired to mill finish, good welds can be obtained in a 3T joint. If a sheet with one Low Res surface is stacked adjacent to another such sheet, the adjacent faying surface is preferably a high resistance surface, such as a mill finish surface, which will provide heat to the faying interface. In general, a Low Res surface positioned adjacent a High Res surface will have better contact uniformity and will result in improved weld performance than if two High Res surfaces are juxtaposed. This improvement in the uniformity of the current transfer across the interfaces provides a significant increase in weld quality and enables 3T welding of aluminum.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated. All such variations and modifications are intended to be included within the scope of the present disclosure.

What is claimed is:

1. A method for resistance welding, comprising:
(A) providing a first member composed at least partially from aluminum;
(B) providing a second member composed at least partially from aluminum, each of the first member and the second member having a first outer surface with a first electrical resistance and a second outer surface with a second electrical resistance and an interior having a third electrical resistance;
(C) reducing the electrical resistance of at least a portion of the first outer surface of the first member to produce a lower resistance surface, the second outer surface of the first member retaining a higher electrical resistance than the lower resistance surface and being a higher resistance surface;
(D) placing the first member against the second member with the higher resistance surface abutting either the first or second outer surface of the second member producing a two-thickness stackup;
(E) providing an electric resistance welder with an anode and a cathode;
(F) positioning the anode against the lower resistance surface and the cathode against the second member of the stackup; and
(G) passing a welding current through the stackup producing a weld between the first member and the second member at the abutting surfaces.

2. The method of claim 1, wherein the step of reducing is by grit blasting the first outer surface, wherein the grit blasting is conducted with aluminum oxide grit producing a surface roughness between 30 μin to 300 μin.

3. The method of claim 1 wherein the step of reducing is by chemical treatment

4. The method of claim 3, wherein the abutting surfaces are mill finish surfaces.

5. The method of claim 3, wherein the first and second outer surfaces of the first and second members include an oxide layer and wherein the oxide layer is thinned on the lower resistance surface during the step of reducing.

6. The method of claim 5, further comprising the step of dressing the anode after the step of passing, and wherein the step of passing is conducted more than 200 times before each step of dressing is conducted.

7. The method of claim 6, further comprising the step of reducing the electrical resistance of the first outer surface of the second member to produce a second lower resistance surface, the cathode being positioned against the second lower resistance surface during the step of positioning.

8. The method of claim 7, further including the steps of providing a third member composed at least partially of aluminum, wherein the stackup of the first member and the second member is a two-thickness stackup and placing the two-thickness stackup abutting against the third member, producing a three-thickness stackup, the abutting surfaces of the two-thickness stackup with the third member each being a faying surface.

9. The method of claim 8, wherein a lubricant disposed on at least one of the first and second surfaces of the first or second member remains on the surface during the step of passing, wherein at least one of the first and second surfaces of the first or second member has a conversion coating that remains on the surface during the step of passing.

10. The method of claim 9, wherein the anode and cathode are composed at least partially of a refractory metal, wherein the refractory metal is tungsten.

11. An aluminum alloy material, comprising:
(A) a first outer surface with a first electrical resistance;
(B) a second outer surface with a second electrical resistance; and
(C) an interior having a third electrical resistance, the electrical resistance of the first outer surface being lower than the second outer surface.

12. The material of claim 11, wherein the first and second outer surfaces include an oxide layer.

13. The material of claim 12, wherein the oxide layer of the first outer surface is thinner than the oxide layer of the second surface.

14. The material of claim 13, wherein the oxide layer of the first outer surface is at least partially composed of amorphous Al₂O₃.

15. A composite, comprising:
a first member composed at least partially from aluminum;
a second member composed at least partially from aluminum, each of the first member and the second member having a first outer surface with a first electrical resistance and a second outer surface with a second electrical resistance and an interior having a third electrical resistance, the electrical resistance of at least a portion of the first outer surface of the first member being lower than the electrical resistance of the second outer surface of the first member, the second outer surface being a higher resistance surface,
the first member juxtaposed with the second member with the higher resistance surface abutting either the first or second outer surface of the second member; and
a weld joining the abutting surfaces of the first member and the second member.

16. The composite of claim 15, wherein the weld is a resistance spot weld.

17. The composite of claim 16, wherein the portion of the first outer surface is a grit blasted surface.

18. The composite of claim 17, wherein the abutting surfaces are mill finish surfaces.
